(19) United States
(12) Patent Application Publication
(10) Pub. No.: US 2026/0268240 A1
(43) Pub. Date: Sep. 10, 2026

(54) METHOD, SYSTEM AND DEVICE FOR OPTIMIZING SIMULATION ACCURACY OF REGIONAL-SCALE PROCESS MODEL

(71) Applicant: China Agricultural University, Beijing (CN)

(72) Inventors: Chenglong ZHANG, Beijing (CN); Gang LI, Beijing (CN); Ya ZHOU, Beijing (CN); Xueer QIN, Beijing (CN); Zailin HUO, Beijing (CN); Zhongyi LIU, Beijing (CN); Xuemin LI, Beijing (CN)

(21) Appl. No.: 19/662,223

(22) Filed: Apr. 29, 2026

(30) Foreign Application Priority Data
May 12, 2025 (CN) 202510606278.1

(51) Int. Cl. G06Q 10/04; G06F 30/27; G06F 111/06; G06Q 50/02

(52) U.S. Cl. CPC G06Q 10/04; G06F 30/27; G06Q 50/02; G06F 2111/06

(57) ABSTRACT

The present disclosure discloses a method, a system and a device for optimizing simulation accuracy of a regional-scale process model, and relates to the field of model optimization technology, comprising: inputting a combination of crop parameters to be optimized into a crop-water productivity model to determine an outcome variable yield and a canopy coverage; performing a cross-validation of the outcome variable yield and the canopy coverage, and determining evaluation indicators; and constructing a multi-objective indicator evaluation optimization model for optimization of key parameters of regional-scale PCMs; wherein the multi-objective indicator evaluation optimization model is configured with minimizing a sum of the NSE of canopy coverage and outcome variable yield in a training set and a test set as objective functions, and with the RMSE as constraints.

### TECHNICAL FIELD

The present disclosure relates to the field of model optimization technology, particularly to a method, a system and a device for optimizing simulation accuracy of a regional-scale process model.

### BACKGROUND

Process-Based Crop Models (PCMs) serve as an important tool for modern agricultural scientific research and resource management. Currently, based on classification of the main driving factors, commonly used PCMs include models driven by soil factors (hydrodynamic and water balance models), photosynthetic factors (CO₂ and radiation-driven), and anthropogenic factors.

From the perspective of model calibration, parameter values are not subject to direct measurement, are recommended in the form of ranges, and admit a large number of possible combinations. This complexity makes it difficult to manually calibrate the model to obtain an optimal parameter combination, thereby hindering effective improvement of the simulation accuracy of regional-scale process models PCMs.

### SUMMARY

The present disclosure provides a method, a system and a device for optimizing simulation accuracy of a regional-scale process model to solve the above-mentioned problem in the prior art, namely, how to improve the simulation accuracy of a region-scale process model PCMs in the prior art; and the present disclosure provides a method for optimizing simulation accuracy of a region-scale process model, the method including:
inputting a combination of crop parameters to be optimized into a crop-water productivity model AquaCrop_OSPy, to determine a simulated crop yield and a simulated canopy coverage; wherein the combination of crop parameters includes product data, measured data, and calibration data;

performing a cross-validation of the crop yield and the canopy coverage using a leave-one-out cross-validation (LOOCV) method, and determining evaluation indicators corresponding to the combination of crop parameters; wherein the evaluation indicators include a Nash-Sutcliffe efficiency coefficient (NSE) and a root mean square error (RMSE);
constructing a multi-objective indicator evaluation optimization model for optimization of key parameters of regional-scale PCMs;
training the multi-objective indicator evaluation optimization model by minimizing a sum of the NSE of canopy coverage and crop yield in a training set and a test set as objective functions, and using the RMSE of canopy coverage and crop yield in the training set and the test set as constraints;
inputting the evaluation indicators into the trained multi-objective indicator evaluation optimization model, solving the multi-objective indicator evaluation optimization model using parallel algorithm portfolios composed of multiple meta-heuristic optimization methods, optimizing the combination of crop parameters, and obtaining an optimal combination of crop parameters.

In some embodiments, solving the multi-objective indicator evaluation optimization model using the parallel algorithm portfolios composed of multiple meta-heuristic optimization methods specifically includes:
solving the multi-objective indicator evaluation optimization model using the parallel algorithms, including UNSGA3, MOEA/D, SPEA2, AGEMOEA, CTAEA and SMSEMOA.

In some embodiments, the product data includes soil hydraulic parameters, soil texture, and meteorological data;

In some embodiments, the measured data includes yield, leaf area index (LAI), irrigation data, and field management data;

In some embodiments, the calibration data includes a research area, a research object, key crop parameters, a search interval, and a search step size.

A system for optimizing simulation accuracy of a regional-scale process model, including:
an acquisition module, configured to input a combination of crop parameters to be optimized into a crop-water productivity model AquaCrop_OSPy, to determine a simulated crop yield and a simulated canopy coverage; wherein the combination of crop parameters includes product data, measured data, and calibration data;
a cross-validation module, configured to perform a cross-validation of the crop yield and the canopy coverage using a leave-one-out cross-validation (LOOCV) method, and determine evaluation indicators corresponding to the combination of crop parameters; wherein the evaluation indicators include a Nash-Sutcliffe efficiency coefficient (NSE) and a root mean square error (RMSE);
a construction module, configured to construct a multi-objective indicator evaluation optimization model for optimization of key parameters of regional-scale PCMs;
a training module, configured to train the multi-objective indicator evaluation optimization model by minimizing a sum of the NSE of canopy coverage and crop yield in a training set and a test set as objective functions, and using the RMSE of canopy coverage and crop yield in the training set and the test set as constraints;
an optimization module, configured to input the evaluation indicators into the trained multi-objective indicator evaluation optimization model, solve the multi-objective indicator evaluation optimization model using parallel algorithm portfolios composed of multiple meta-heuristic optimization methods, optimize the combination of crop parameters, and obtain an optimal combination of crop parameters.

The present disclosure provides a computer device, including: a memory, a processor, and a computer program stored on the memory and executable on the processor, wherein the processor, when executing the computer program, implements the above-described method for optimizing simulation accuracy of a regional-scale process model.

Compared with the existing technology, the beneficial effects of the present disclosure are as follows: The present disclosure provides a method for optimizing the simulation accuracy of a regional-scale process model. By combining a meta-heuristic optimization method with LOOCV, key crop parameters of PCMs are optimized under conditions of limited measured data. Based on evaluation indicators obtained through the LOOCV process, a multi-objective indicator evaluation optimization model is constructed by minimizing a sum of the NSE of canopy coverage and outcome variable yield in a training set and a test set as objective functions, and using the RMSE as constraints. The multi-objective indicator evaluation optimization model is solved by the parallel algorithm portfolios, thereby yielding an optimal combination of crop parameters, which effectively improves both simulation accuracy and calibration efficiency of PCMs at a regional scale.

### BRIEF DESCRIPTION OF THE DRAWINGS

The accompanying drawings are incorporated into the specification and form part thereof; they illustrate embodiments that are consistent with the present disclosure, and together with the specification serve to explain the principles of the present disclosure.

FIG. 1 is a flow chart of a method for optimizing simulation accuracy of a regional-scale process model according to an embodiment of the present disclosure;

FIG. 2 is a technical roadmap of a method for optimizing simulation accuracy of a regional-scale process model according to an embodiment of the present disclosure;

FIG. 3 is a schematic diagram of a leave-one-out cross-validation method according to an embodiment of the present disclosure;

FIG. 4 is a schematic diagram of a computer device of a method for optimizing simulation accuracy of a regional-scale process model according to an embodiment of the present disclosure.

### DETAILED DESCRIPTION

In order to make the objectives, the technical solutions, and the advantages of the present disclosure clearer, the following clearly and completely describes the technical solutions in embodiments of the present disclosure with reference to the embodiments of the present disclosure. Apparently, the described embodiments are only some, but not all, of the embodiments of the present disclosure. All other embodiments obtained by those of ordinary skill in the art based on the embodiments of the present disclosure, without involving any creative effort, shall fall within the scope of protection of the present disclosure.

The following specific embodiments provide a detailed description of the technical solution of the present disclosure and how it addresses the aforementioned technical problems. These specific embodiments may be combined interchangeably; concepts or processes that are identical or similar may not be repeated in certain embodiments. The embodiments of the present disclosure will now be described with reference to the accompanying drawings.

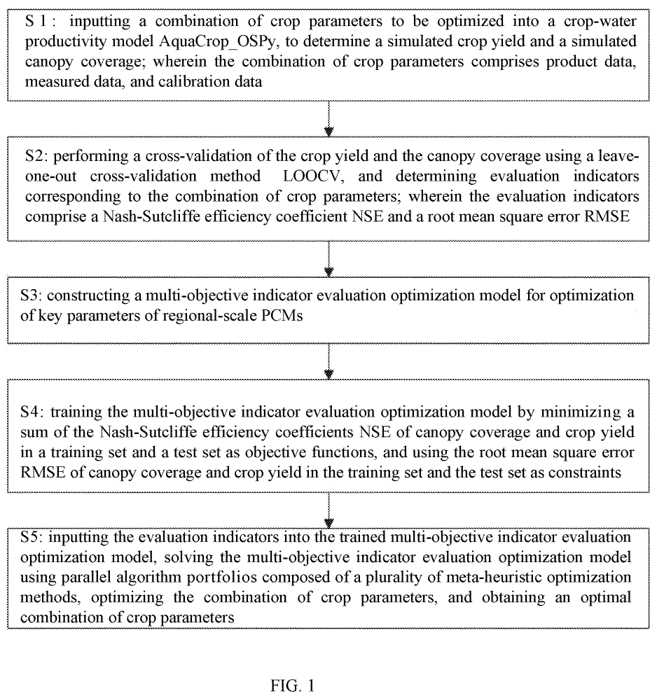

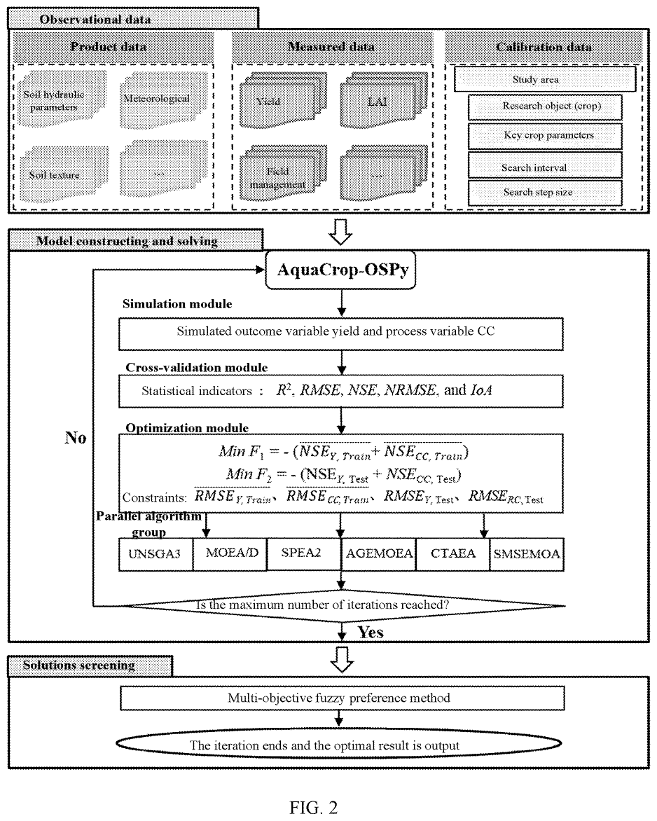

As shown in FIGS. 1-2, a method for optimizing the simulation accuracy of a region-scale process model is provided by the embodiment, the method includes:

S1: the combination of crop parameters to be optimized is input into the crop-water productivity model AquaCrop_OSPy, to determine the simulated crop yield and the simulated canopy coverage; wherein the combination of crop parameters includes product data, measured data, and calibration data.

As an example, product data, measured data and calibration data with representative spatio-temporal differences can be retrieved from multiple academic databases.

In some embodiments, the product data includes soil hydraulic parameters, soil texture, and meteorological data; the measured data includes yield, LAI, and field management data; and the calibration data includes the research area, the research object, key crop parameters, the search interval, and the search step size.

S2: the cross-validation of the crop yield and the canopy coverage is performed using the LOOCV, and the evaluation indicators corresponding to the combination of crop parameters are determined; wherein the evaluation indicators include the NSE and the RMSE;

In general, the water-driven AquaCrop model is a representative daily-scale water balance generalized crop model, which is primarily applied to arid areas where water constitutes a key limiting factor for crop production. AquaCrop requires only a limited number of explicit parameters, and the input data are intuitive, clear, and readily obtainable. The model has been widely utilized in irrigation system formulation, management measure optimization, and crop yield prediction for a variety of crops across diverse regions. It possesses the capability to simulate crop yield at different scales, including point, county, and region, and exhibits significant potential in guiding agricultural irrigation water conservation in arid areas. In the AquaCrop model, CC is an intuitive indicator directly associated with crop evapotranspiration and biomass.

### Canopy Coverage Development Stage:

$$C C = \{ \begin{matrix}{CC}_{0} {e}^{tCGC} & CC \leq \frac{{CC}_{x}}{2} \\ {CC}_{x} - 0.25 \frac{{CC}_{x}^{2}}{{CC}_{0}} {e}^{- tCGC} & CC > \frac{{CC}_{x}}{2}\end{matrix}$$

### Canopy Coverage Aging Process:

$$CC = {CC}_{x} [ 1 - 0.05 ( {e}^{\frac{CDC}{{CC}_{x}} t} - 1 ) ]$$

where CC₀ denotes the initial CC when the emergence rate reaches 90%, CCₓ denotes the maximum CC, CGC denotes the canopy growth coefficient, CDC is the canopy decline coefficient, and t is the number of days after sowing.

The key process of transformation from CC to crop yield and biomass may be expressed as:

$${CC}^{*} = 1 \text{.72} CC - {CC}^{2} + 0 \text{.30} {CC}^{3}$$

$${T}_{r} = {K}_{s} {CC}^{*} {K}_{{C}_{Tr ,} x} {ET}_{0}$$

$$B = {K}_{{S}_{b}} {WP}^{*} \sum Tr / {ET}_{0}$$

$$Y = {f}_{HI} {HI}_{0} B$$

where CC* denotes the modified CC, which primarily accounts for inter-row reflectivity variation and a masking effect caused by partial overlapping of the canopy; Tᵣ denotes the crop transpiration; Kₛ denotes the soil water stress coefficient, including soil water stress, stomatal closure stress, and soil salt stress; K_{C}_{_{Tr}}_{,x} denotes the maximum crop transpiration coefficient corresponding to a fully irrigated soil and a fully covered canopy; K_{S}_{_{b}} denotes the air temperature stress coefficient; WP* denotes the normalized water productivity; Y denotes the crop yield; f_{HI} denotes the adjusting factor accounting for the effects of water stress and pollination failure prior to yield formation, and the impact of water stress during yield formation; HI₀ denotes a reference harvest index; and B denotes final biomass.

The relationship between CC and LAI may be expressed as:

$$CC = 1.005 \cdot {( 1 - {e}^{- 0.6 * LAI} )}^{1.2}$$

S3: the multi-objective indicator evaluation optimization model for optimization of key parameters of regional-scale PCMs is constructed.
S4: the multi-objective indicator evaluation optimization model is trained by minimizing the sum of the NSE of canopy coverage and crop yield in the training set and the test set as objective functions, and using the RMSE of canopy coverage and crop yield in the training set and the test set as constraints.

Wherein the multi-objective indicator evaluation optimization model is configured with minimizing the sum of NSE of canopy coverage and crop yield in the training set and the test set as objective functions, and with the RMSE as constraints.

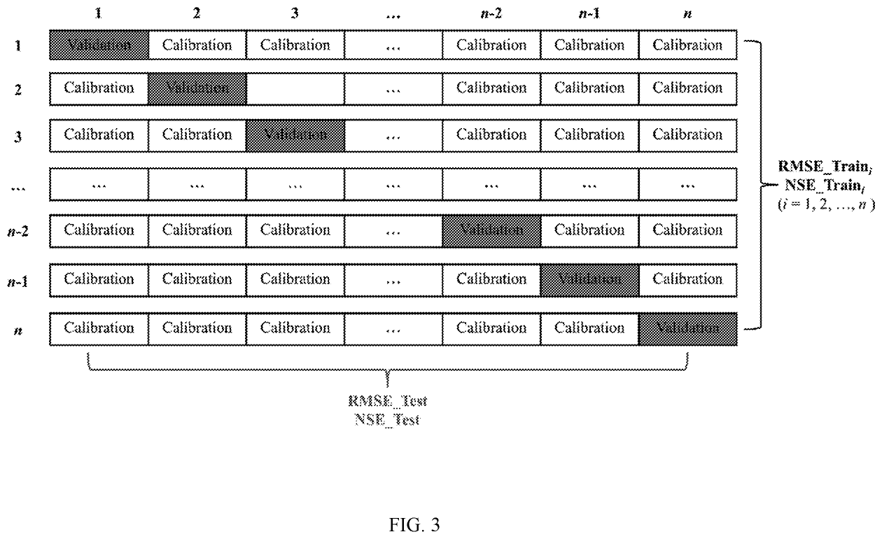

As shown in FIG. 3, by employing the LOOCV, the regression model parameters are estimated by successively omitting one sample and utilizing the remaining samples, which renders the method suitable for learning with small sample datasets. LOOCV avoids errors arising from random partitioning of datasets, which better reflects the distribution characteristics of the original samples, and provides a verification process that is fully repeatable. In FIG. 2: RMSE_Trainᵢ and NSE_Trainᵢ denote the root mean square error and the Nash-Sutcliffe efficiency coefficient (where i=1, 2, . . . , n) of the training set at the i^{th} cross-validation, respectively. RMSE_Test and NSE_Test denote the root mean square error and the Nash-Sutcliffe efficiency coefficient of the test set upon completion of all cross-validations, respectively.
S5: the evaluation indicators are input into the trained multi-objective indicator evaluation optimization model, the multi-objective indicator evaluation optimization model is solved using the parallel algorithm portfolios composed of multiple meta-heuristic optimization methods, the combination of crop parameters is optimized, and the optimal combination of crop parameters is obtained.

As an example, according to the limitations of the actual data that can be collected and the research objectives, the measured process variable canopy coverage CC and the outcome variable yield are used as the calibration indicators of the model. The dimensionless NSE on the training set and the test set is selected as the optimization target, and the dimensionless RMSE is used as the constraint.

Objective 1: Minimizing the NSE of the training set:

$$Min {F}_{1} = - \{ \overline{{NSE}_{Y , Train}} + \overline{{NSE}_{CC , Train}} \}$$

where F₁ is the sum of the crop yield obtained by the LOOCV method and the average NSE of the CC training set, ‘-’ is the negative value of the fitness value set to the objective function; N̅S̅E̅_̅{̅Y̅,̅T̅r̅a̅i̅n̅}̅ is the average NSE of the training set yield; and N̅S̅E̅_̅{̅C̅C̅,̅T̅r̅a̅i̅n̅}̅ is the average NSE of the training set CC.

### Objective 2: Minimizing the NSE of the Test Set:

$$Min {F}_{2} = - \{ {NSE}_{Y , Test} + {NSE}_{CC , Test} \}$$

where F₂ is the sum of the yield obtained by the LOOCV method and the NSE of the CC test set, ‘−’ is the negative value of the fitness value set to the objective function; NSE_{Y,Test} is the NSE of the test set yield; and NSE_{CC,Test} is the NSE of the test set CC.

The constraints include:

$$\overline{{RMSE}_{Y , Train}} \leq {RMSE}_{Y , crop}$$

$${RMSE}_{Y , Test} \leq {RMSE}_{Y , crop}$$

$$\overline{{RMSE}_{CC , Train}} \leq {RMSE}_{CC , crop}$$

$${RMSE}_{CC , Test} \leq {RMSE}_{CC , crop}$$

where R̅M̅S̅E̅_̅{̅Y̅,̅T̅r̅a̅i̅n̅}̅ and R̅M̅S̅E̅_̅{̅C̅C̅,̅T̅r̅a̅i̅n̅}̅ are averaged RMSE of the yield and the CC training sets, respectively, RMSE_{Y,Test} and RMSE_{CC,Test} are RMSE of the yield and the CC test sets, respectively; and RMSE_{Y,crop} and RMSE_{CC,crop} are constraint values of the yield and the CC, respectively. Different values are taken according to the different calibration crops. The penalty function method is used to deal with the constraints, the constraints play a role in accelerating the convergence of the algorithm and meeting the requirements of the minimum simulation accuracy of the model.
S5: by inputting the evaluation indicators into the multi-objective indicator evaluation optimization model, the multi-objective indicator evaluation optimization model is solved using the parallel algorithm portfolios composed of multiple meta-heuristic optimization methods, and the optimal combination of crop parameters is obtained iteratively.

As an example, each parameter within the combination of crop parameters possesses a respective search interval and search step size. There are N combinations of crop parameters composed of parameters, and the present application seeks to identify an optimal combination among them. The search interval is based on the interval range values of default parameters of the model, and may be comprehensively determined according to existing knowledge, historical data, or via random searching and multiple model runs. The search step size may be set according to practical requirements of each parameter so as to achieve an optimal balance. In an iterative process, by introducing the combination of crop parameters into the PCMs, a superior combination is retained according to the evaluation indicators and the optimization model; thereafter, the algorithm generates a new combination, and the new and previous combination of crop parameters are again introduced into the PCMs, with the above process being continuously repeated. The output thereof constitutes a state variable of the optimization model for a next period: the evaluation indicators are obtained by introducing the combination into the PCMs, and optimization is performed based on these indicators, i.e., the state variable of the optimization model for the next period.

The foregoing describes the method for optimizing simulation accuracy of a regional-scale process model provided by one or more embodiments of the present specification. Based on the same concept, the present specification further provides a corresponding system for optimizing the simulation accuracy of a regional-scale process model, the system includes:
an acquisition module, configured to input the combination of crop parameters to be optimized into the crop-water productivity model AquaCrop_OSPy, to determine the simulated crop yield and the simulated canopy coverage; wherein the combination of crop parameters includes product data, measured data, and calibration data;
a cross-validation module, configured to perform the cross-validation of the crop yield and the canopy coverage using the LOOCV, and determine evaluation indicators corresponding to the combination of crop parameters; wherein the evaluation indicators include the NSE and the RMSE;
a construction module, configured to construct the multi-objective indicator evaluation optimization model for optimization of key parameters of regional-scale PCMs;
a training module, configured to train the multi-objective indicator evaluation optimization model with minimizing the sum of the NSE of canopy coverage and crop yield in the training set and the test set as objective functions, and with the RMSE of canopy coverage and crop yield in the training set and the test set as constraints;
an optimization module, configured to input the evaluation indicators into the trained multi-objective indicator evaluation optimization model, solve the multi-objective indicator evaluation optimization model using the parallel algorithm portfolios composed of multiple meta-heuristic optimization methods, optimize the combination of crop parameters, and obtain an optimal combination of crop parameters.

For specific definitions concerning the system for optimizing simulation accuracy of a regional-scale process model, reference may be made to the definitions of the method for optimizing simulation accuracy of a regional-scale process model provided hereinabove; such definitions are not repeated here for brevity. The various modules within the aforementioned system for optimizing simulation accuracy of the regional-scale process model may be implemented in whole or in part by software, hardware, or a combination thereof. These modules may be embedded in, or configured to operate independently of, a processor within a computer device in hardware form, or may be stored in a memory of a computer device in software form, such that a processor is capable of calling and executing operations corresponding to each of the aforementioned modules.

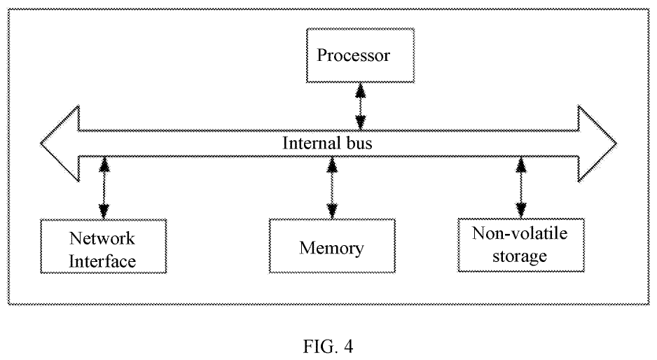

The present disclosure also provides a schematic diagram of the structure of a computer device, which is illustrated in FIG. 4. As shown in FIG. 4, at a hardware level, the computer device includes a processor, an internal bus, a network interface, a memory, and a non-volatile memory. Naturally, the computer device may also include other hardware required for additional operations. The processor reads a corresponding computer program from the non-volatile memory into the memory and thereafter executes the same to implement the method for optimizing simulation accuracy of the regional-scale process model provided by the above-described embodiments.

The technical features of the above-described embodiments may be combined in any manner. The brevity of the description means that not all possible combinations of the technical features in the aforementioned embodiments have been described; yet, any combination of these technical features that is not contradictory should be considered to fall within the scope of the present disclosure.

What is claimed is:

1. A method for optimizing simulation accuracy of a regional-scale process model, comprising:
inputting a combination of crop parameters to be optimized into a crop-water productivity model AquaCrop_OSPy, to determine a simulated crop yield and a simulated canopy coverage;
wherein the combination of crop parameters comprises product data, measured data, and calibration data; the product data comprises soil hydraulic parameters, soil texture, and meteorological data; the measured data comprises yield, leaf area index LAI, irrigation data, and field management data; and the calibration data comprises a research area, a research object, key crop parameters, a search interval, and a search step size;
performing a cross-validation of the crop yield and the canopy coverage using a leave-one-out cross-validation method LOOCV, and determining evaluation indicators corresponding to the combination of crop parameters; wherein the evaluation indicators comprise a Nash-Sutcliffe efficiency coefficient NSE and a root mean square error RMSE;
constructing a multi-objective indicator evaluation optimization model for optimization of key parameters of regional-scale PCMs;
training the multi-objective indicator evaluation optimization model by minimizing a sum of the Nash-Sutcliffe efficiency coefficients NSE of canopy coverage and crop yield in a training set and a test set as objective functions, and using the root mean square error RMSE of canopy coverage and crop yield in the training set and the test set as constraints;
the constraints specifically comprise:
$$\overline{{RMSE}_{Y , Train}} \leq {RMSE}_{Y , crop}$$
$${RMSE}_{Y , Test} \leq {RMSE}_{Y , crop}$$
$$\overline{{RMSE}_{CC , Train}} \leq {RMSE}_{CC , crop}$$
$${RMSE}_{CC , Test} \leq {RMSE}_{CC , crop}$$
where R̅M̅S̅E̅_̅{̅Y̅,̅T̅r̅a̅i̅n̅}̅ and R̅M̅S̅E̅_̅{̅C̅C̅,̅T̅r̅a̅i̅n̅}̅ are averaged RMSE of crop yield and canopy coverage CC training sets, respectively; RMSE_{Y,Test} and RMSE_{CC,Test} are RMSE of crop yield and canopy coverage CC test sets, respectively; and RMSE_{Y,crop} and RMSE_{CC,crop} are constraint values of crop yield and canopy coverage CC, respectively;
inputting the evaluation indicators into the trained multi-objective indicator evaluation optimization model, solving the multi-objective indicator evaluation optimization model using parallel algorithm portfolios composed of a plurality of meta-heuristic optimization methods, optimizing the combination of crop parameters, and obtaining an optimal combination of crop parameters;
further comprising:
in an iterative process, by introducing the combination of crop parameters into the PCMs, acquiring a new combination of crop parameters according to the evaluation indicators and the multi-objective indicator evaluation optimization model, and again introducing the combination of crop parameters and the new combination of crop parameters into the PCMs, and continuously repeating the above-described steps until an optimal combination of crop parameters is obtained.

2. The method for optimizing simulation accuracy of a regional-scale process model according to claim 1, wherein solving the multi-objective indicator evaluation optimization model using the parallel algorithm portfolios composed of a plurality of meta-heuristic optimization methods specifically comprises:
solving the multi-objective indicator evaluation optimization model using the parallel algorithms, comprising UNSGA3, MOEA/D, SPEA2, AGEMOEA, CTAEA and SMSEMOA.

3. A system for optimizing simulation accuracy of a regional-scale process model, comprising:
an acquisition module, configured to input a combination of crop parameters to be optimized into a crop-water productivity model AquaCrop_OSPy, to determine a simulated crop yield and a simulated canopy coverage; wherein the combination of crop parameters comprises product data, measured data, and calibration data; the product data comprises soil hydraulic parameters, soil texture, and meteorological data; the measured data comprises yield, leaf area index LAI, irrigation data, and field management data; and the calibration data comprises a research area, a research object, key crop parameters, a search interval, and a search step size;
a cross-validation module, configured to perform a cross-validation of the crop yield and the canopy coverage using a leave-one-out cross-validation method LOOCV, and determine evaluation indicators corresponding to the combination of crop parameters; wherein the evaluation indicators comprise a Nash-Sutcliffe efficiency coefficient NSE and a root mean square error RMSE;
a construction module, configured to construct a multi-objective indicator evaluation optimization model for optimization of key parameters of regional-scale PCMs;
a training module, configured to train the multi-objective indicator evaluation optimization model by minimizing a sum of the Nash-Sutcliffe efficiency coefficients NSE of canopy coverage and crop yield in a training set and a test set as objective functions, and by using the root mean square error RMSE of canopy coverage and crop yield in the training set and the test set as constraints; the constraints specifically comprise:
$$\overline{{RMSE}_{Y , Train}} \leq {RMSE}_{Y , crop}$$
$${RMSE}_{Y , Test} \leq {RMSE}_{Y , crop}$$
$$\overline{{RMSE}_{CC , Train}} \leq {RMSE}_{CC , crop}$$
$${RMSE}_{CC , Test} \leq {RMSE}_{CC , crop}$$
where R̅M̅S̅E̅_̅{̅Y̅,̅T̅r̅a̅i̅n̅}̅ and R̅M̅S̅E̅_̅{̅C̅C̅,̅T̅r̅a̅i̅n̅}̅ are averaged RMSE of crop yield and canopy coverage CC training sets, respectively; RMSE_{Y,Test} and RMSE_{CC,Test} are RMSE of crop yield and canopy coverage CC test sets, respectively; and RMSE_{Y,crop} and RMSE_{CC,crop} are constraint values of crop yield and canopy coverage CC, respectively;
an optimization module, configured to input the evaluation indicators into the trained multi-objective indicator evaluation optimization model, solve the multi-objective indicator evaluation optimization model using parallel algorithm portfolios composed of a plurality of meta-heuristic optimization methods, optimize the combination of crop parameters, and obtain an optimal combination of crop parameters;
further comprising:
an iterative optimization module, configured to, in an iterative process, by introducing the combination of crop parameters into the PCMs, acquire a new combination of crop parameters according to the evaluation indicators and the multi-objective indicator evaluation optimization model, and again introduce the combination of crop parameters and the new combination of crop parameters into the PCMs, and continuously repeat the above-described steps until an optimal combination of crop parameters is obtained.

4. A computer device, comprising: a memory, a processor, and a computer program stored on the memory and executable on the processor, wherein the processor, when executing the computer program, implements the method for optimizing simulation accuracy of a regional-scale process model according to claim 1.
